(19) United States
(12) Patent Application Publication
(10) Pub. No.: US 2019/0015724 A1
(43) Pub. Date: Jan. 17, 2019

(54) GOLF SWING CORE BASIC TRAINING ASSISTING DEVICE

(71) Applicant: Li-Wei Yang, New Taipei City (TW)

(72) Inventor: Li-Wei Yang, New Taipei City (TW)

(21) Appl. No.: 15/869,083

(22) Filed: Jan. 12, 2018

(30) Foreign Application Priority Data
Jul. 11, 2017 (TW) 106210199

(51) Int. Cl. A63B 69/36

(52) U.S. Cl. CPC A63B 69/3641; G09B 19/0038

(57) ABSTRACT

A golf swing core basic training assisting device is applicable to training of takeaway and follow-through of a golf swing motion and generally includes a bottom board that is set at heels of a player and in parallel therewith. A rotation shaft is rotatably mounted to each of two sides of the bottom board. The rotation shafts are arranged to extend at predetermined best angles along outer sides of foot soles. As such, the arrangement of the rotation shafts allows for exhibition, in a tangible form, of an angle of a club in takeaway and follow-through, allowing the player to timely observe correctness of the club angle and to guide the body to turn correctly, and to set the club head on a correct swing trace to thereby strengthen muscle memory and improve performance of learning so as to establish excellent basis for swing motions.

### (A) TECHNICAL FIELD OF THE INVENTION

The present invention relates generally to a device for assisting training of golf swing, and more particularly to a golf swing core basic training assisting device that is designed to allow for practical observation the accuracy of club angle in takeaway and follow-through in order to strength muscle memory and set up excellent basis of swing.

### (B) DESCRIPTION OF THE PRIOR ART

Every person who plays golf know that the swing of golf, from a standing posture before upswing to takeaway to a top point of swing (the upper body driving the lower body), and converting from the top point to a downswing to impact, follow-through, and the final finish (the lower body driving the upper body), all require the entire body, upper and lower parts, including the head position, two arms, wrists, shoulders, and waist to rotate to shift of gravity center of two feet to coordinate with each other, in combination with accuracy of shot posture, to completely release the force of the club head to make a correct and powerful impact. Such a swing operation almost entirely rely on mutual coordination and integration of every muscle from the head to the feet and is a very smooth and skillful motion, of which the secret can be handled only by repeatedly and continuous practicing and training to make the muscles move to generate muscle memory, allowing for smoothly and naturally make a desired swing movement.

For the entire swing operation, takeaway and follow-through are the most important motions and are the basis for extension to all other motions and is the core of the entire swing operation. For a beginner, core basic training for correct takeaway and follow-through is extremely vital.

### SUMMARY OF THE INVENTION

The primary objective of the present invention is to provide a golf swing core basic training assisting device, which allows for exhibition of club angle in takeaway and follow-through in a tangible form to allow a user to actually observe the accuracy of the club angle and to guide the body to do correct turning in order to set the club head in a correct swing trace to thereby strengthen muscle memory and to enhance learning performance and thus establish excellent basis of swing.

To achieve the above objective, the present invention is generally made up of a bottom board and two rotation shafts, wherein the bottom board is set at heels of a golf swing trainee and in parallel therewith and the rotation shafts are rotatably mounted to two sides of the bottom board to extend at predetermined best angles along outer sides of foot soles for takeaway and follow-through. As such, the arrangement of the angles defined by the two rotation shafts allows for exhibition, in a tangible form, of an angle of a club in takeaway and follow-through, allowing for observation of correctness of the club angle in takeaway and follow-through by the player or a trainer in swing core basic training or by the player or a trainer to make timely correction, and also to guide the body to turn correctly and to remove unnecessary excessive amount of turning to thereby set the club head on a correct swing trace and to strengthen muscle memory and improve performance of learning so as to establish excellent basis for swing motions and improve skills.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view showing a structure of the present invention.

FIG. 2 is a perspective view showing the present invention.

FIG. 3 is a schematic view showing an operation of the present invention.

FIG. 4 is a schematic view illustrating correction of a takeaway motion according to the present invention.

FIG. 5 is a schematic view illustrating an instance of impact according to the present invention.

FIG. 6 is a schematic view illustrating correction of a follow-through motion according to the present invention.

FIG. 7 is a schematic view illustrating a process from takeaway to follow-through according to the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

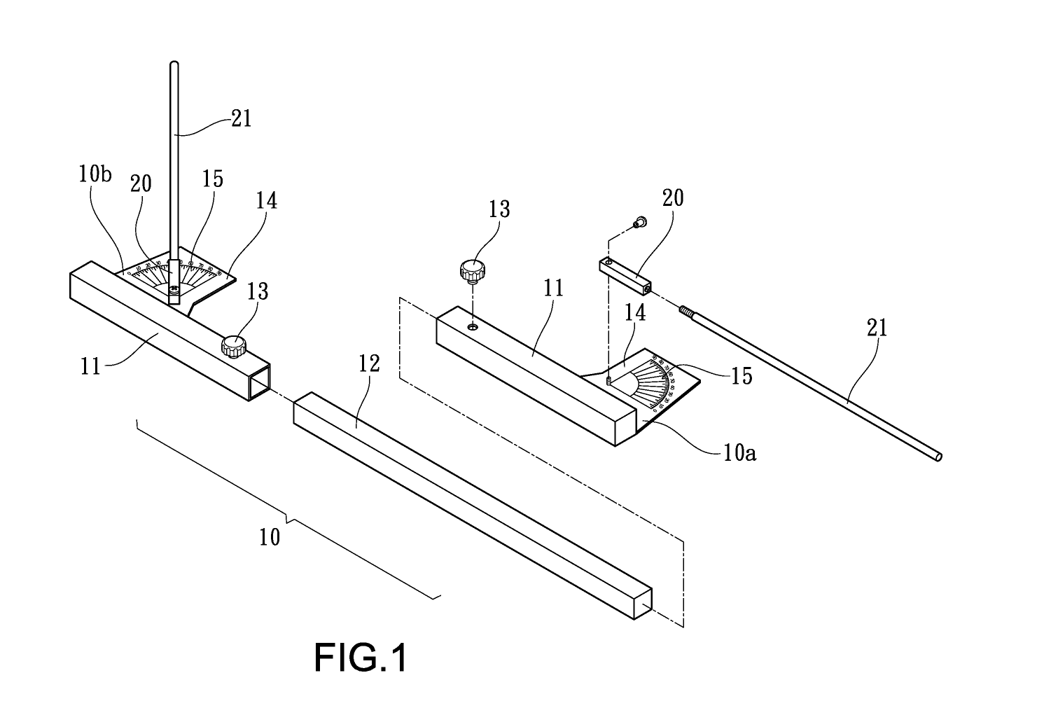

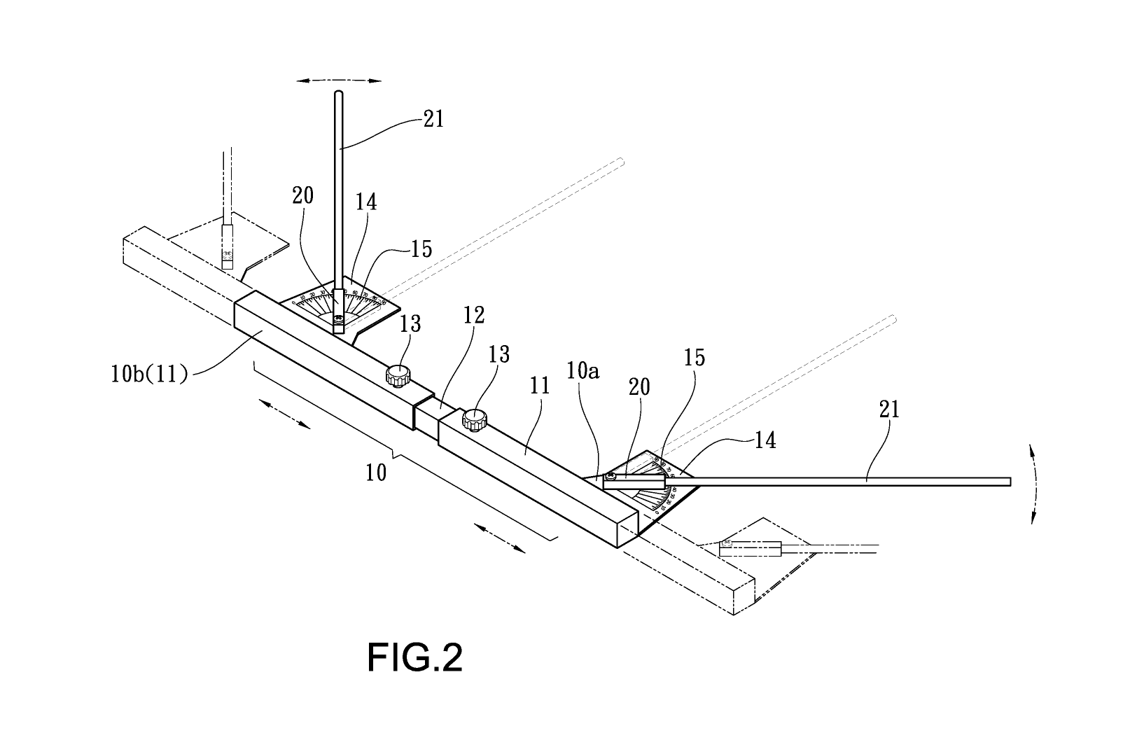

Referring to FIGS. 1-3, the present invention provides a golf swing core basic training assisting device, which is generally made up of a bottom board 10 and two rotation shafts 20, wherein the bottom board 10 is arranged, in a parallel manner, at a site of the heels of a golf player 30 and the rotation shafts 20 are rotatably mounted, in an angle adjustable manner, to two sides of the bottom board 10 and are set to extend, alongside outer edges of foot soles of the player 30, in predetermined angles so as to define reference lines for an angle of a club 31 in takeaway and follow-through.

The above mentioned bottom board 10, in the instant preferred embodiment, is further made up of two plates 10a, 10b that are set symmetric in a left-right direction. Each of the plates 10a, 10b has a side edge that is provided with a corresponding sleeve 11, in a manner of being slidably fit over two ends of an internal tube 12, so as to form a leftward/rightward movable and extendable/retractable, width adjustable, bottom board 10 to fit to users of different body sizes, allowing a user to adjust to the most suitable width thereby enhancing the adaptability of this invention. Further, the sleeve 11 of each of the plates 10a, 10b is provided, at a suitable location, with a rotary knob 13 to allow for securely fixing of the plate after the adjustment to a desired width is done. Further, the bottom board 10 of the present invention is further provided with an outward-extending plate member 14 extending from a pivotal joint of each of the rotation shafts 20 in a direction along an axis thereof towards an operation end and the plate member 14 is provided, in a manner of directly carving or printing or by means of adhesive thereon, with an angle gauge pattern 15 for the purpose of serving as a reference for adjusting and setting an angle of the rotation shaft 20.

The rotation shafts 20, in a preferred embodiment of the present invention, for the purpose of convenience of assembly and use, are such that the rotation shafts 20 are each made in the form of a short bar rotatably mounted to the bottom board 10 with an extension bar 21 being fastened, through screwing, to the operation end of each of the rotation shafts 20 for extension of the overall length of the rotation shaft 20 for use and also being removable, in a condition of not being used, to reduce the overall size of easy storage. Further, in an alternative practical arrangement, the rotation shafts 20 can be each made in the form of an extendible/retractable rod so that extension can be achieved by pulling out and stretching the operation end to increase the overall length of the bar.

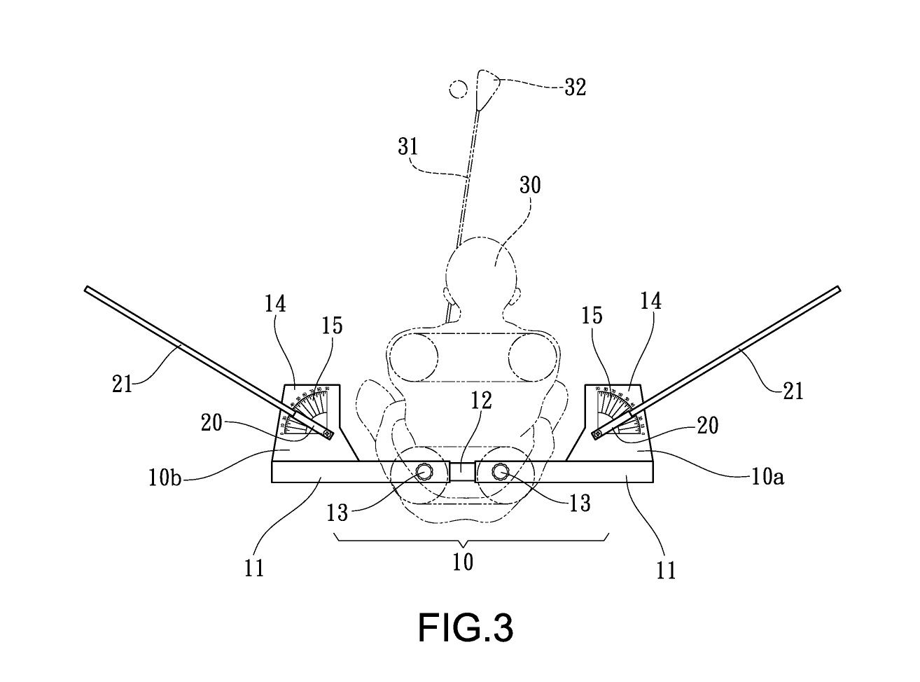

Referring to FIG. 3, to use the present invention, the bottom board 10 is adjusted to a desired width according to personal body size and is set at and substantially parallel to the heels of the player 30. The rotation shafts 20 that are located on the left and right sides of the player 30 are adjusted to correct angular positions at which takeaway and follow-through of the club 31 are to be made. By then taking a posture for address, a core basic training for swing can be proceeded with.

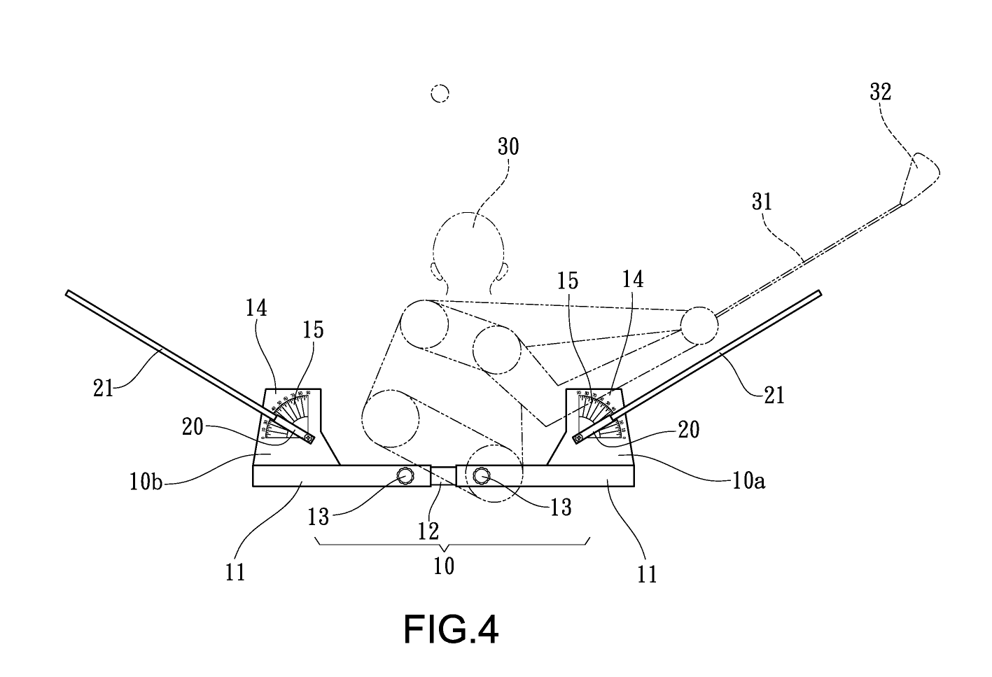

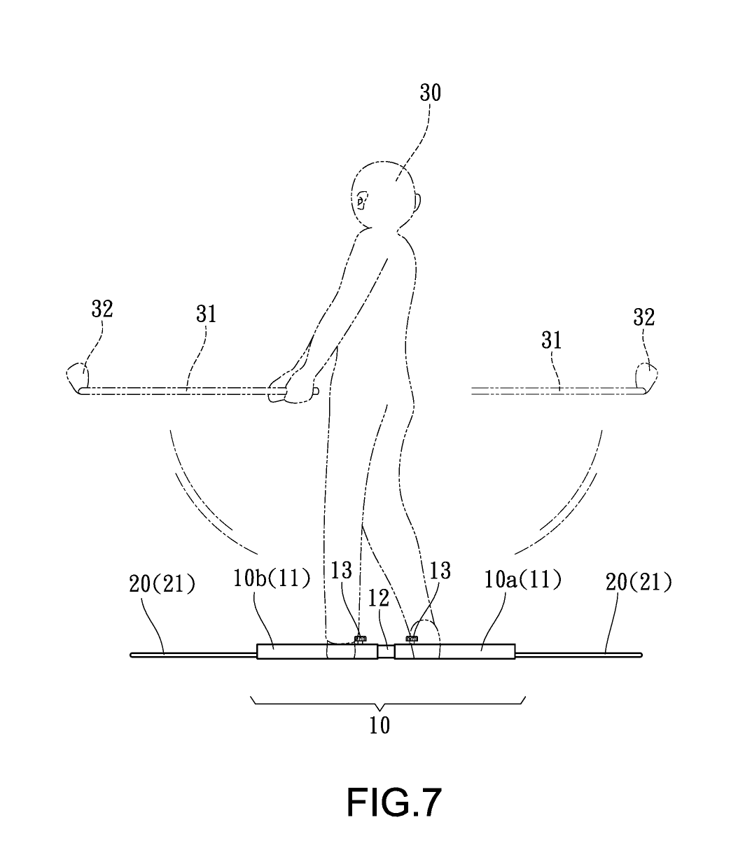

Referring to FIGS. 4-7, the swing core basic training of this invention is that the primary training is the bodying making 180 degree turning (90 degrees for takeaway and 90 degrees for follow-through) (see FIG. 7). In takeaway, the two wrists and arms of the player 30 (right-handed player) move around a center defined by the head, in coordination with correct rotation of shoulders and body and shifting of the center of gravity, to smoothly move the club 31 to the right side (left arm maintaining straight, while right arm slightly curved), so that when the club head 32 reaches the height of waist, the club 31 is generally parallel with the ground (see FIG. 7), and at this moment, the player 30 may make observation by himself or herself or observation can be made by a trainer, regarding if the club 31 is generally parallel with the right-side rotation shaft 20 (as shown in FIG. 4). In case of undesired deviation, correction of body posture can be made immediately to find out the problem to thereby making the club 31, in takeaway, parallel to the right-side rotation shaft 20.

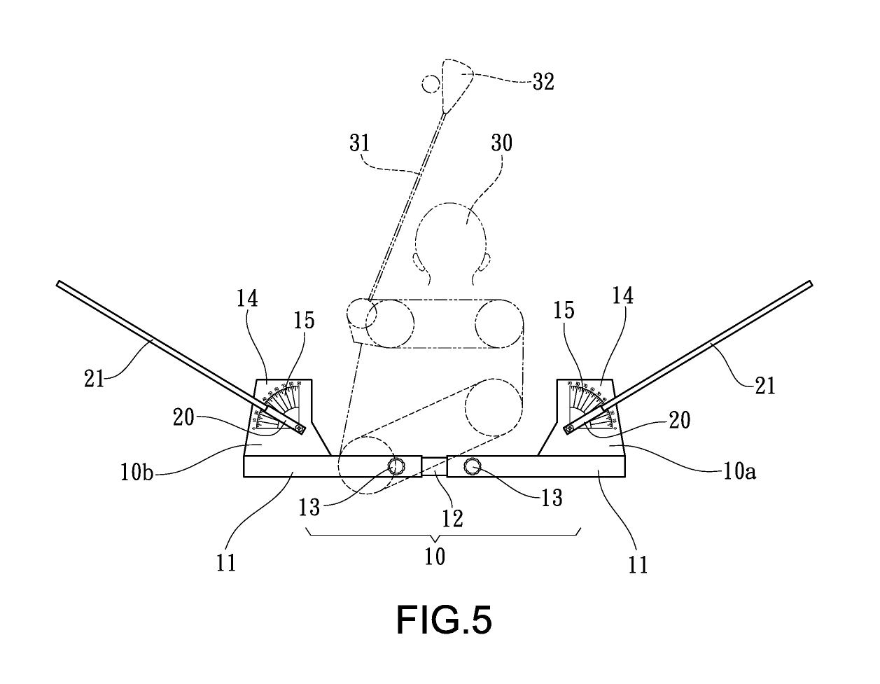

During downswing, based on correct rotation of waist and shifting of the center of gravity, movement of axis and rotation of shoulders guide the two hands to swing the club 31 to the left side to set the club head 32 in a correct path to pass through a ball shot zone (as shown in FIG. 5), to thereby release the force of the club head for accurate and powerful impact of the ball.

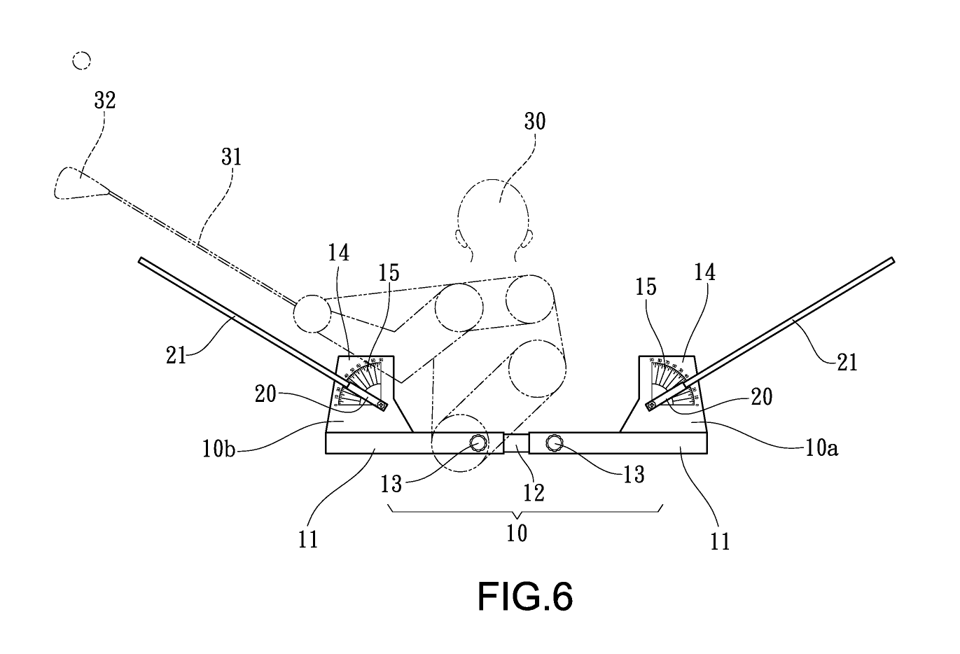

Finally, during the follow-through, the body continues rotating leftward and the center of gravity is shifted to the left foot, with the left foot upright and right knee approaching the left knee, the right shoulder moving down, the body rotating to such a position of facing the target, the arm fully stretching to make the club 31 generally parallel with the ground (see FIG. 7), and at this moment, observation can be made again regarding if the club 31 for forward is set at a correct angle of being parallel with the left-side rotation shaft 20 (see FIG. 6), thereby guiding the body to turn correctly and setting the club head on the correct swing path.

It can be known from the above that the golf swing core basic training assisting device of the present invention provides the following practical advantages:

(1) The assisting device converts club angles of takeaway and follow-through that are intangible into a tangible form of exhibition to thereby allow for effective discovery and recognition of deficiency of impact posture and to allow for timely correction in order to enhance performance of learning and improve skills.

(2) Training conducted with the assisting device would provide guidance for correctly turning the body and also help remove excessive turning to set the club head on a correct swing trace to thereby generate excellent swing rhythm, achieve relative balance of swing, and enhance swing performance and increase explosiveness.

(3) Training conducted with the assisting device would effectively improve motion perception and strengthen muscle memory to convert each posture of muscles and correct contraction of each motion into memory stored in the brain to thereby establish excellent basis of swing.

(4) Training conducted with the assisting device prompts overall coordination, flexibility, and rhythm of a human body, so as to ensure consistency of swing motions and provide better stabilized, faster, and smoother swing trace to create faster club head speed and effectively enhance shot range and correctness of direction.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. A golf swing core basic training assisting device, comprising:
a bottom board, the bottom board being adapted to set at heels of a golf swing trainee in a manner of being parallel therewith; and
two rotation shafts, which are rotatably mounted, in a movable manner, to two sides of the bottom board to extend forward at predetermined angles along outsides of foot soles to form reference axes for an angle of a club for takeaway and follow-through in swing core basic training;
wherein correctness of the angle of the club can be observed in practicing swing and a user body is guided to turn to set a club head on a correct swing trace and further to strengthen muscle memory and improve performance of learning to establish excellent basis for swing.

2. The golf swing core basic training assisting device according to claim 1, wherein the bottom board comprises two plates that are symmetric in a left-right direction, the plates being each provided on an edge thereof with a sleeve corresponding thereto and slidably fit over two ends of an internal tube to form a leftward/rightward movable and extendable/retractable, width adjustable, configuration of the bottom board.

3. The golf swing core basic training assisting device according to claim 2, wherein the sleeve of each of the plates is provided with a rotary knob for selectively fixing the plate after adjustment to a desired width.

4. The golf swing core basic training assisting device according to claim 1, wherein the bottom board is provided, at a pivotal joint of each of the rotation shafts, with a plate member that extends outward in a direction along an axis to an operation end, the plate member being provided thereon with an angle gauge pattern for setting an angle of the rotation shaft.

5. The golf swing core basic training assisting device according to claim 2, wherein the bottom board is provided, at a pivotal joint of each of the rotation shafts, with a plate member that extends outward in a direction along an axis to an operation end, the plate member being provided thereon with an angle gauge pattern for setting an angle of the rotation shaft.

6. The golf swing core basic training assisting device according to claim 4, wherein the angle gauge pattern is provided through direct carving or printing on or attaching by means of adhesive to the plate member.

7. The golf swing core basic training assisting device according to claim 5, wherein the angle gauge pattern is provided through direct carving or printing on or attaching by means of adhesive to the plate member.

8. The golf swing core basic training assisting device according to claim 1, wherein each of the rotation shafts is made in the form of a bar of which an operation end is contractible/retractable.

9. The golf swing core basic training assisting device according to claim 2, wherein each of the rotation shafts is made in the form of a bar of which an operation end is contractible/retractable.

10. The golf swing core basic training assisting device according to claim 1, wherein an operation end of each of the rotation shafts is coupled to an extension bar.

11. The golf swing core basic training assisting device according to claim 2, wherein an operation end of each of the rotation shafts is coupled to an extension bar.
